(19) United States
(12) Patent Application Publication
(10) Pub. No.: US 2026/0081255 A1
(43) Pub. Date: Mar. 19, 2026

(54) TRACTION BATTERY WHICH CAN BE TEMPERATURE-CONTROLLED BY MEANS OF A FLUID

(71) Applicant: KAUTEX TEXTRON GMBH & CO. KG, Bonn (DE)

(72) Inventors: Moritz LIPPERHEIDE, Bonn (DE); Erik ELBAEK, Mainz-Kastel (DE); Daniel MARX, Bedburg (DE)

(21) Appl. No.: 19/107,941

(22) PCT Filed: Aug. 25, 2023
(86) PCT No.: PCT/EP2023/073394

§ 371 Date: Feb. 28, 2025

(30) Foreign Application Priority Data
Aug. 30, 2022 (DE) 10 2022 121 853.8

(51) Int. Cl. H01M 10/6556; B60L 50/64; B60L 58/26; H01M 10/613; H01M 10/625; H01M 10/6568; H01M 50/249

(52) U.S. Cl. CPC H01M 10/6556; B60L 50/64; B60L 58/26; H01M 10/613; H01M 10/625; H01M 10/6568; H01M 50/249; H01M 2220/20

(57) ABSTRACT

A traction battery which can be temperature-controlled by means of a fluid includes a battery housing, at least one battery module which is arranged in the interior of the battery housing and has at least one battery cell, at least one heat sink which is arranged inside the battery housing and includes at least one metal, wherein the heat sink is in direct or indirect contact with the at least one battery module and wherein the heat sink has at least one cooling fluid connection point and at least one internally arranged cooling fluid channel fluidically connected to the cooling fluid connection point.

The present invention relates to a traction battery which can be temperature-controlled by means of a fluid, in particular for electric vehicles such as BEVs (battery electric vehicles), FCEVs (fuel cell electric vehicles), FHEVs (full hybrid electric vehicles) or PHEVs (plug-in hybrid electric vehicles). The present invention also relates to a motor vehicle, in particular a BEV or PHEV, comprising a traction battery according to the invention.

The prior art discloses various types of traction batteries for vehicles with electric drive, during the charging and discharging of which high levels of power are transferred. Such high-power batteries can presently be operated with voltages of up to several hundred volts. In addition, presently charging and discharging currents of several hundred amperes can occur. In principle, higher voltages and currents are also possible in future developments.

In the traction batteries, the large charging and discharging currents cause large thermal losses which result in heating. In order to protect the batteries from thermal damage and to achieve high efficiency, it is important to keep the batteries within a desired temperature range. Therefore, heat must be removed from the battery. Present battery cells using lithium-ion technology work best in a narrow temperature range of, for example, 15° to 40° C. with a high degree of temperature homogeneity and a temperature fluctuation of 2 to 4° C. within the battery cells.

To ensure these conditions, battery cells of traction batteries are cooled during operation, i.e., during charging and/or discharging. Various types of cooling are presently used, such as liquid cooling.

Conversely, for the same reasons, it may be advantageous to heat the battery cells in the case of low outside temperatures.

In principle, these systems can involve active or passive circulation of the heat transport medium in order to remove the released heat by convection. In passive circulation, the heat transport medium is moved exclusively by a temperature gradient within the heat transport medium, whereas in active circulation, the heat transport medium is actively circulated in order to remove the heat from the battery cells.

The object of the present invention is to provide an improved traction battery whose optimal operating temperature can be reliably maintained. In particular, efficient cooling or heating as well as high stability and modularity of the traction battery should be achieved.

The object of the present invention is achieved by a traction battery having the features of claim 1. Advantageous embodiments of the housing apparatus are described in the claims dependent on claim 1.

More specifically, the object of the present invention is achieved by a traction battery which can be temperature-controlled by means of a fluid, comprising a battery housing and at least one battery module which is arranged in the interior of the battery housing and has at least one battery cell. The battery module may have its own housing (battery module housing). Alternatively, the traction battery can be constructed in the “cell-to-pack” design. In this case, the battery cells themselves form the battery module and are not arranged in a separate housing. At least one heat sink consisting substantially of a metal is arranged in the interior of the battery housing. The heat sink is in direct or indirect contact with the at least one battery module. Furthermore, the heat sink has at least one cooling fluid connection point and at least one internally arranged cooling fluid channel fluidically connected to the cooling fluid connection point.

The traction battery can be any suitable traction battery, in particular a traction battery for use in a motor vehicle, preferably in a BEV or a PHEV. The traction battery can preferably be a traction battery using lithium-ion technology. A traction battery can also be referred to as a battery pack.

The traction battery has a battery housing. The battery housing has a wall and encloses an interior, which can also be referred to as the volume of the battery housing. The wall of the battery housing has a side facing the interior and which can be referred to as the inside. The wall of the housing further has a side facing away from the interior and can be referred to as the outside or as facing the surroundings.

The battery housing, in particular its wall, can be made of or comprise any suitable material. For example, the battery housing or its wall can be made substantially of a metal, preferably aluminum. Preferably, the battery housing or its wall can be made substantially of a plastics material, in particular substantially of a composite plastics material.

The battery housing can have two half-shells that have been connected to one another to form the battery housing. In particular, the battery housing can have a top shell and a bottom shell. The terms “top shell” and “bottom shell” relate to the arrangement of the two half-shells relative to one another when the traction battery according to the invention is installed in a motor vehicle.

The battery housing can also have at least one opening for feeding the cooling fluid connection point of the heat sink through, the cooling fluid connection point being described below. Such an opening can preferably be a cutout in the wall, in particular the wall of the bottom shell of the battery housing. Alternatively or additionally, the battery housing can likewise have at least one cooling fluid connection point which is fluidically connected to the cooling fluid connection point of the heat sink.

The battery housing can also have a connection point for a CAN interface.

The battery module can be any suitable battery module, in particular a battery module using lithium-ion technology. The battery module can be an independent component separate from the battery housing. Preferably, a plurality of battery modules, in particular ≥2, ≥3, or ≥4 battery modules, are arranged within the battery housing. In addition to the battery cells described below, the battery module can have sensors and a system for establishing contact among the battery cells. Furthermore, the battery module can have a battery module housing. The battery module housing can have a wall and then encloses an interior, which can also be referred to as the volume of the battery module housing. The wall of the battery module housing can have a side facing the interior and which can be referred to as the inside. The wall of the battery module housing can also have a side facing away from the interior and which can be referred to as the outside. The battery module can also have a top side and a bottom side. The terms “top side” and “bottom side” relate to the arrangement of the two sides relative to one another when the battery module is properly installed in the battery housing.

Preferably, the battery module is connected to the battery housing, in particular the bottom shell of the battery housing. The connection between the battery module and the battery housing is discussed in detail below. In the case of the connection of the battery module to the bottom shell of the battery housing, the bottom side of the battery module and the inside of the bottom shell of the battery housing are arranged facing one another or towards one another. The battery module and the battery housing can be connected to one another non-detachably or preferably detachably.

The wall of the battery module can consist of any suitable material. Examples of materials for the wall of the battery module can be plastics material or metal.

The battery module also has at least one battery cell. This battery cell can be arranged in the interior of the battery module or of the battery module housing. The battery cell can be any suitable battery cell; in particular, it can be a lithium-ion battery cell. The battery cell can be a round cell, a pouch cell or a prismatic cell. Preferably, a plurality of battery cells, in particular more than ≥2, ≥6 or ≥10 battery cells, are arranged within a battery module.

The metal heat sink can be a component separate from the battery module and/or from the battery housing. As previously stated, the heat sink can in principle be used for the temperature control, i.e., also the heating, of the traction battery. Accordingly, the term “heat sink” or the term “cooling plate” can also always be used below to refer to a body or plate that serves to heat the traction battery.

Preferably, the heat sink can be connected to the battery housing, in particular the bottom shell or the top shell of the battery housing. Also preferably, at least one heat sink can be connected to the bottom shell of the battery housing and at least one further heat sink can be connected to the top shell of the battery housing. The connection between the heat sink and the battery housing is discussed below. In the case of the connection of the heat sink to the bottom shell of the battery housing, the bottom side of the heat sink and the inside of the bottom shell of the battery housing are arranged facing one another or towards one another. In the case of the connection of the heat sink to the top shell of the battery housing, the top side of the heat sink and the inside of the top shell of the battery housing are arranged facing one another or towards one another. The heat sink and the battery housing can be connected to one another non-detachably or preferably detachably. The heat sink and the battery module can be connected to one another either non-detachably or detachably.

As previously described, a heat sink can be connected to the top shell and/or the bottom shell of the battery housing. In the following, only the connection of the heat sink to the bottom shell of the battery housing is described. The same statements apply analogously to the alternative or additional connection of a heat sink to the top shell of the battery housing. In this case, the bottom side of the heat sink contacts the top side of the battery module.

The metal heat sink is a heat sink made substantially, preferably entirely, of metal. The metal can be a transition metal or a light metal. Preferably, the metal can have a thermal conductivity of ≥160 W/(m*K). More preferably, the thermal conductivity of the metal can be ≥190, ≥205, ≥230, ≥285, ≥305 or ≥377 W/(m*K). The metal can be copper and in particular aluminum.

The use of a metal heat sink leads to an increase in rigidity, in particular in the case of a battery housing made of plastics material. This eliminates the need for stiffening ribs of the battery housing, creating space for additional battery modules.

According to the invention, the heat sink is in direct or indirect contact with the battery module. The contact can be thermal contact. Preferably, the top side of the heat sink and the bottom side of at least one battery module are in contact with one another at least in some regions. More preferably, substantially the entire bottom side of the battery module can be in contact with at least one heat sink. The contact between the heat sink and the battery module is contact that is suitable for allowing heat transfer between the heat sink and the battery module, whereby heat is also indirectly transferred from/to the battery cell.

A thermal interface material (TIM) can also be arranged between the battery module and the heat sink. In such a case, the heat sink contacts the battery module indirectly. The thermal interface material can be, for example, a thermal paste, a thermal adhesive, a graphite and/or aluminum foil, or an aluminum hydroxide material. The thermal interface material is preferably a thermal paste, more preferably a silicone-free thermal paste, in particular a two-component thermal paste. The thermal paste may have a composition that allows it to cure at room temperature. The thermal interface material may have a substantially plate-or film-like shape. The maximum thickness of the thermal interface material can preferably be in a range of ≥0.1 mm and ≤5 mm, ≥0.1 mm and ≤2 mm, or ≥0.1 mm and ≤1 mm.

The heat sink also has at least one cooling fluid connection point. The cooling fluid connection point can have at least one feed and at least one return. The feed and return of a cooling fluid connection point can be spatially separated from one another and/or arranged on different sides of the heat sink. Preferably, the feed and return are arranged on the same side of the heat sink. The feed and return can be or are fluidically connected to a heat exchanger, in particular a heat exchanger for a motor vehicle. Likewise, the feed and return can be or are fluidically connected to a fluid pump, in particular a coolant pump of a motor vehicle.

There is at least one cooling fluid channel connected to the cooling fluid connection point and arranged inside the heat sink. Preferably, the heat sink has exactly one cooling fluid channel with two openings, both of which open into the cooling fluid connection point. In particular, the first of the two openings can open into the feed, while the second of the two openings opens into the return.

An internal cooling fluid channel or cooling fluid channel arranged inside the heat sink is understood to mean that the cooling fluid channel is produced integrally with the heat sink and, for example, has not been applied to the heat sink. In particular, the wall of the cooling fluid channel is substantially completely formed of the material of the heat sink.

The cooling fluid can preferably be water or an aqueous solution. The expression “can be temperature-controlled by means of a fluid” means that the traction battery, in particular the battery module or the battery cells, can exchange heat with the cooling fluid and can thereby be heated or, in particular, cooled.

The heat sink can preferably be in the form of a cooling plate. A plate is a substantially planar structure whose thickness is less than its length and width. The maximum thickness of the cooling plate can preferably be in a range of ≥2 mm and ≤9 mm, ≥2 mm and ≤7 mm, or ≥2 mm and ≤5 mm. The minimum thickness of the cooling plate can preferably be in a range of ≥1 mm and ≤2 mm, preferably 1.7 mm. Particularly preferably, the cooling plate can have a maximum thickness of 5 mm and a minimum thickness of 1.7 mm. The heat sink, in particular the cooling plate, can be designed and/or suitable for an internal pressure of up to 3.5 bar (absolute pressure).

The length of the cooling plate can be in a range of ≥500 mm≤2500 mm, preferably ≥500 mm and ≤600 mm, preferably 540 mm. The width of the cooling plate can be in a range of ≥270 mm and ≤1300 mm, preferably ≥270 mm and ≤310 mm, preferably 295 mm. The wide side of the cooling plate can preferably be the shorter side and/or the side of the cooling plate to which the cooling fluid connection point is attached. If the cooling fluid connection point is attached to the shorter side of the cooling plate, this advantageously ensures increased stability of the cooling plate.

The heat sink or the cooling plate can preferably consist of two metal sheets, in particular aluminum sheets, connected to one another. Particularly preferably, the cooling plate can be produced using the roll-bonding process. This has the advantage that the fluid channel can be introduced, simply and with an easily defined geometry, into the cooling plate during the production of the cooling plate. The roll-bonding process is familiar to a person skilled in the art. In this process, two metal sheets are joined together by rolling at high pressure, i.e., pressure-joined, wherein certain parts of the sheet which later form the cooling fluid channel are left out of the joining process by treating these regions with release agents, for example by printing, before the rolling. After the joining, these unconnected regions between the two metal sheets are inflated using compressed air to create the cooling fluid channels. The thickness of an individual metal sheet after roll-bonding can be 1 mm.

The metal material of the top side of the cooling plate can be different from or identical to the metal material of the bottom side of the cooling plate. Preferably, the top side and the bottom side of the cooling plate can be made of aluminum 1050. Alternatively, the top side of the cooling plate can be made of aluminum 1250 or aluminum 3003 and the bottom side of aluminum 1050. These grades of aluminum showed excellent properties in the temperature control of automotive traction batteries.

A cooling plate has a top side and a bottom side; the top side of the cooling plate faces the battery module. It has been found that the heat transfer between the battery module and the cooling plate can be improved if the top side of the cooling plate, i.e., the side of the cooling plate facing the battery module, is flat. This means that the top side of the cooling plate has substantially no elevations due to the cooling fluid channel which runs inside the cooling plate. Preferably, “flat” can be understood here as meaning that a region of the top side of the cooling plate below which the cooling fluid channel runs protrudes ≤1 mm, or ≤0.5 mm above a region of the top side of the cooling plate below which no cooling fluid channel runs. Preferably, this height difference can be ≤0.3 mm, ≤0.2 mm or ≤0.1 mm.

The flat top side of the cooling plate can be created, for example, by pressing the later top side of the cooling plate against a counter bearing during the inflation operation in the roll-bonding process and thereby preventing bulging of the cooling fluid channels on the later top side.

Preferably, the bottom side of the cooling plate can further comprise elevations which are formed by the fluid channel which runs inside the cooling plate. In other words, the bottom side of the cooling plate is preferably not flat. The regions of the cooling plate that lie between or next to the elevations on the bottom side of the cooling plate can be advantageously used to fasten the cooling plate to the battery housing. For this purpose, the cooling plate can have one or more through-openings in these regions.

The cooling fluid channel may have a substantially semicircular cross section, wherein the straight side of this semicircle corresponds to the top side of the cooling plate. The maximum internal height of the cooling fluid channel can be in a range of ≥2 mm and ≤8 mm, preferably ≥2 mm and ≤4 mm, preferably 3 mm. The maximum internal width of the cooling fluid channel can be in a range of ≥15 mm and ≤40 mm, ≥15 mm and ≤25 mm, ≥17 mm and ≤21 mm, preferably 19 mm. The minimum radius of the cooling fluid channel may preferably be about 3.6 mm. The minimum distance between two regions of the cooling plate in which the cooling fluid channel runs can preferably be in a range of ≥3 mm and ≤7 mm, preferably 4 mm. This distance can also be referred to as the minimum distance between two (adjacent) cooling loops of the cooling fluid channel.

The design of the cooling fluid channel in these mentioned ranges led to particularly efficient heat transfer in automotive traction batteries and also to improved rigidity of the traction battery. Furthermore, these parameters achieve a reduced flow velocity of the coolant. Preferably, the flow velocity of the coolant within the cooling fluid channel can be ≤2.5 m/s.

The cooling fluid channel arranged in the heat sink can have a meandering course. The cooling fluid channel can be in the form of a cooling winding, in particular a serpentine cooling winding. This ensures the most efficient heat exchange possible. Furthermore, the rigidity of the traction battery is likewise advantageously increased.

The heat sink, in particular the cooling plate, can also comprise a collar or seam which at least partially but preferably completely surrounds the heat sink. Advantageously, this collar or seam can run in an edge region of the heat sink. The collar or seam can run at least partially on one, two, three or four sides of the cooling plate. The collar or seam can run at least partially on one or both of the shorter and/or one or both of the longer sides of the cooling plate. Such a border around the heat sink advantageously increases the rigidity of the heat sink and thus of the traction battery.

The battery module can be connected to the battery housing, in particular the bottom shell of the battery housing, at a first fastening point, while the heat sink can be connected to the battery housing, in particular the bottom shell of the battery housing, at a second fastening point, the first and second fastening points being at a distance from one another, such that the position tolerances of the battery module and of the heat sink in the Z-direction are substantially identical. This allows further improved temperature control of the traction battery to be achieved, since the battery module and heat sink are lifted/moved to the same extent in the Z-direction during the travel of the motor vehicle and the resulting vibrations, thus improving the continuous contact between the battery module and the heat sink. The Z-direction runs substantially orthogonally to the main plane of the cooling plate, for example the top side of the cooling plate, and in the case of a traction battery or cooling plate installed in a vehicle, it points upwards, or in the direction from the cooling plate towards the battery module.

The distance between the first and second fastening points can be a minimized distance; in particular, it can be in a range of at most ≥5 mm and ≤20 mm, preferably ≥11 mm and ≤16 mm.

The battery module and/or the heat sink can be connected to the battery housing at the fastening point by screw fastening. The respective fastening axes from the battery module to the battery housing and from the heat sink to the battery housing can be arranged parallel to one another.

A plurality of fluidically connected heat sinks, in particular cooling plates, can preferably be arranged in the interior of the battery housing to generate a cooling circuit. In this case, the feeds of the individual heat sinks can be fluidically connected in parallel. Alternatively or additionally, the returns of the individual heat sinks can be fluidically connected in parallel. >1 and ≤50, ≥4 and ≤36, preferably ≥10 and ≤22 fluidically connected heat sinks can be arranged in the interior of the battery housing.

The cooling fluid connection point, or the fluid channel(s) formed by the cooling fluid connection point, can be arranged substantially in the plane of the cooling plate. The plane of the cooling plate can run parallel to the top side and/or bottom side of the cooling plate, i.e., it can substantially be spanned by the length extent and width extent of the cooling plate itself. Advantageously, such an arrangement of the cooling fluid connection point of the cooling plate minimizes pressure loss in comparison with the case in which the cooling fluid connection point is not located in the plane of the cooling plate, but rather, for example, is perpendicular thereto and points upwards. As previously stated, the cooling fluid connection point arranged in the plane of the cooling plate can preferably be arranged on the shorter side of the cooling plate.

The cooling fluid connection point can have a device for reducing the pressure drop. Particularly preferably, this may be a throttle, in particular a throttle having a calibration region. The throttle can also be referred to as a reduction. In particular, the device for reducing the pressure drop can be arranged in the return of the cooling fluid connection point. Likewise, the device for reducing the pressure drop can be arranged in the return and/or in the feed of the cooling fluid connection point.

The device for reducing the pressure drop has a fluid channel through which the cooling fluid flows. It also has at least one region of this fluid channel over which the cross section of the fluid channel is reduced. The reduction can be a concentric reduction or an eccentric reduction, with the concentric reduction being preferred. This region may be the calibration region. Preferably, by means of the reduction, the cross section of the fluid channel in particular the cross section of the cooling fluid connection point of the heat sink-is reduced to the cross section of the cooling fluid channel of the heat sink, thereby reducing the pressure loss.

The length of this calibration region can vary for cooling fluid connection points of different heat sinks, in particular cooling plates.

The calibration region can have a length in the range of ≥12 mm and ≤22 mm, preferably ≥14 mm and ≤20 mm.

The traction battery can be fluidically connected, by means of its cooling fluid connection point, to a fluid line. Upstream of the feed and/or downstream of the return in the fluid flow direction, a reducer can then be arranged within this fluid line. This allows a hydraulic balancing to take place.

The bottom shell of the battery housing can have at least two support ribs on which the heat sink rests. Preferably, the bottom shell of the battery housing has ≥2 and ≤40, preferably ≥10 and ≤25 support ribs. The support ribs can be arranged on the inside of the bottom shell, i.e., can protrude into the interior of the battery housing. The support ribs can be formed integrally with the bottom shell of the battery housing. The support ribs can also be arranged uniformly, i.e., substantially equidistantly, over the longitudinal extent of the battery housing. In this case, the support ribs can run at a right angle to the longitudinal extent of the battery housing. The support ribs advantageously ensure stable support and fastening of the heat sink and/or of the battery module arranged on the heat sink. The distance between two support ribs can be ≥50 mm and ≤100 mm, preferably ≥70 mm and ≤90 mm.

The heat sink can preferably rest on the support ribs by means of its regions that are arranged between the fluid channel running in the heat sink. The heat sink can also preferably rest on the support ribs by means of its edge region.

Further advantages, details, and features of the invention can be found below in the described exemplary embodiments. In the figures, in detail:

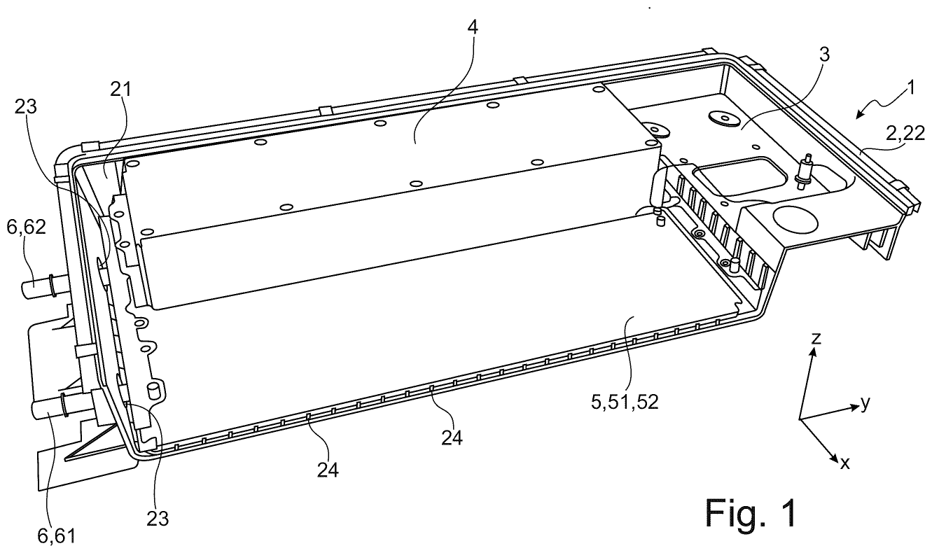

FIG. 1 is a schematic representation of a first embodiment of the traction battery according to the invention which can be temperature-controlled by means of a fluid.

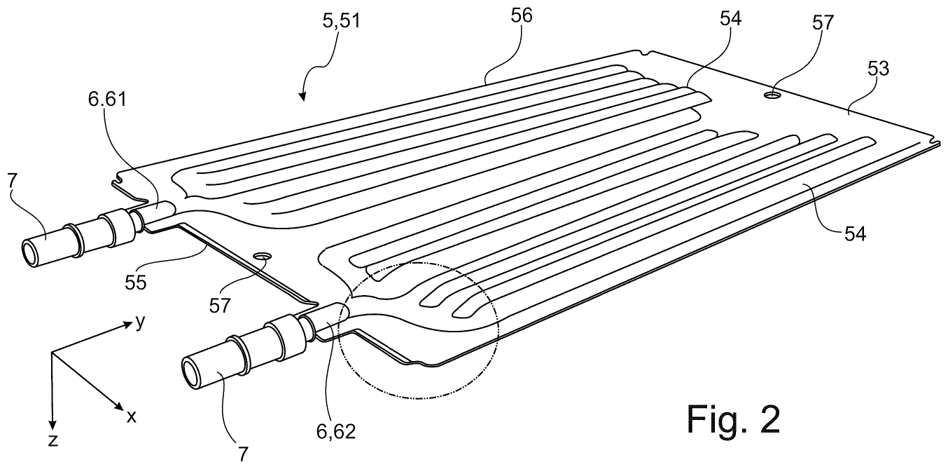

FIG. 2 is a schematic representation of a heat sink according to the invention in the form of a cooling plate.

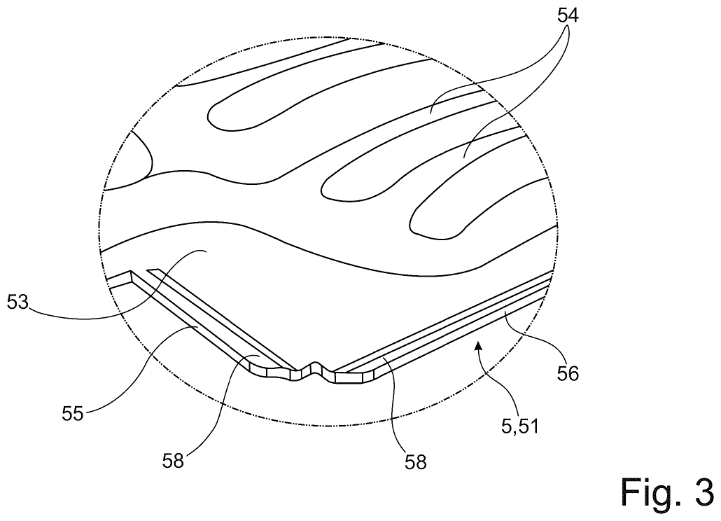

FIG. 3 is a schematic representation of a detail from FIG. 2.

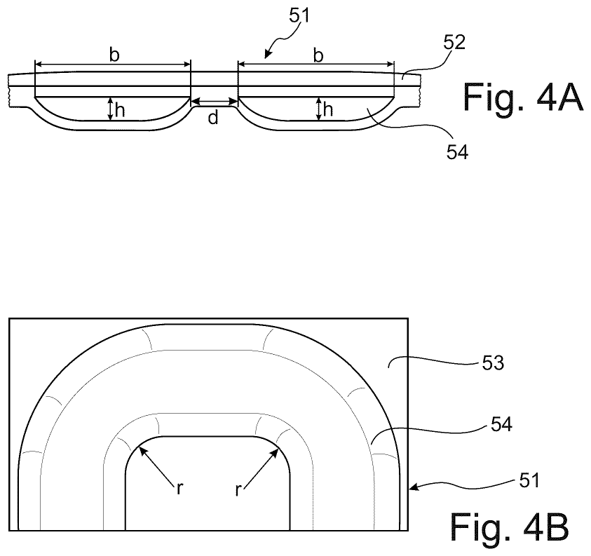

FIG. 4A is a section through the cooling plate according to FIG. 2.

FIG. 4B is a plan view of a detail of the bottom side of the cooling plate according to FIG. 2.

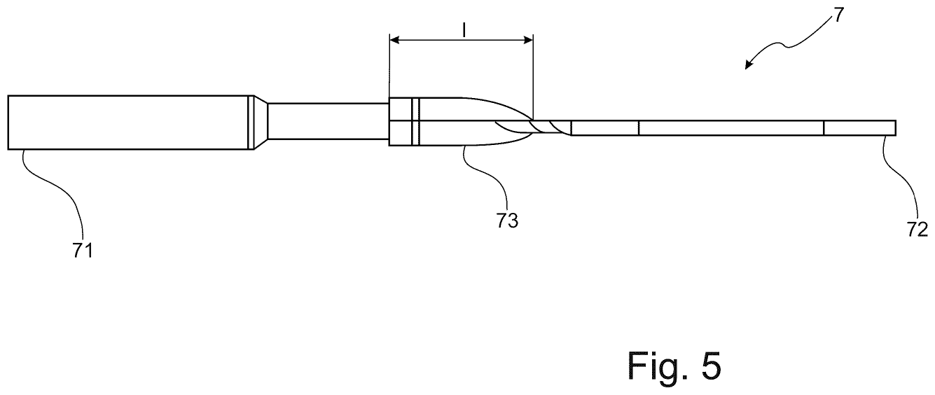

FIG. 5 is a schematic representation of a device for reducing the pressure drop according to FIG. 2.

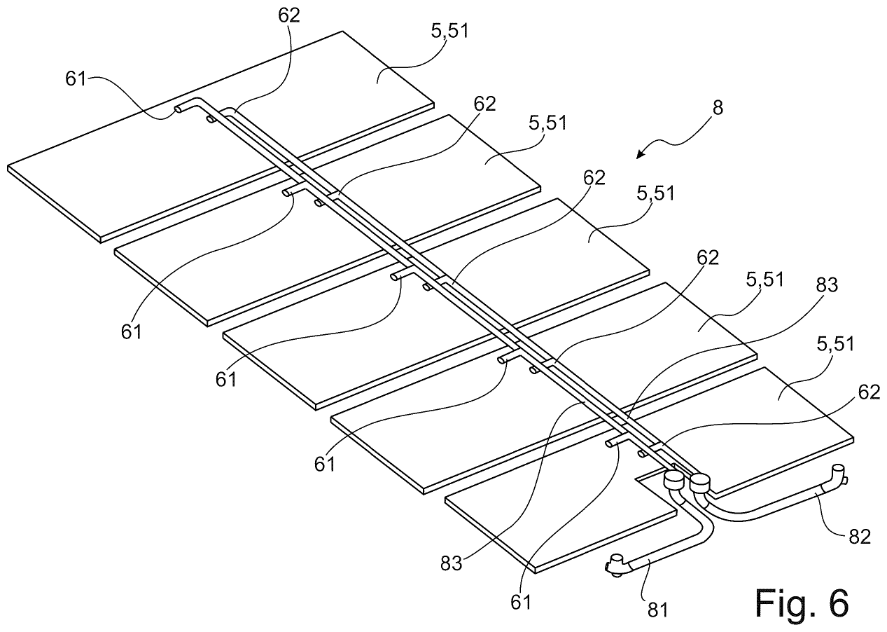

FIG. 6 is a schematic representation of a plurality of fluidically connected heat sinks according to the invention.

In the following description, the same reference signs denote the same components or features, such that a description of a component with reference to one figure also applies to the other figures.

FIG. 1 shows a section through a first embodiment of the traction battery 1 according to the invention which can be temperature-controlled by means of a fluid. The traction battery 1 is a traction battery for use in a motor vehicle, in particular a BEV.

The traction battery 1 has a battery housing 2 with a wall 21. The battery housing 2 or its wall 21 delimits the interior 3 of the battery housing.

The battery housing 2 is made of a plastics material or a composite plastics material. The battery housing 2 consists of two half-shells 22. FIG. 1 shows only a part of one of the two half-shells 22, namely the bottom shell of the battery housing 2.

In the interior 3, only one of a plurality of battery modules 4 arranged here is shown, as well as a heat sink 5 in the form of a cooling plate 51.

The battery modules 4 each have a plurality of lithium-ion battery cells, which are not shown in FIG. 1.

The cooling plate 51 is made of two aluminum plates using the roll-bonding process, in particular aluminum 1050 and/or aluminum 1250. The cooling plate 51 also has a maximum thickness in a range of ≥2 mm and ≤5 mm. The cooling plate 51 also has a minimum thickness in a range of ≥1 mm and ≤2 mm. The thickness of the cooling plate 51 corresponds to the extent of the cooling plate 51 in the Z-direction. The length of the cooling plate is in a range of ≥500 mm and ≤600 mm. The width of the cooling plate is in a range of ≥270 mm and ≤310 mm.

The cooling plate 51 and the battery module 4 are in indirect thermal contact via a thermal interface material in the form of a cured, silicone-free two-component thermal paste, the thermal interface material being arranged between the cooling plate 51 and the battery module 4 and not being shown in the figure.

The cooling plate 51 has an individual internally arranged cooling fluid channel with a meandering course. The cooling fluid channel is not shown in FIG. 1.

The cooling plate 51 rests on 25 support ribs 24, which were formed integrally with the bottom shell of the battery housing 22. The support ribs 24 are evenly distributed over the longitudinal extent of the battery housing 2 and arranged at a right angle thereto. The distance between two adjacent support ribs 24 is in a range of ≥70 mm and ≤90 mm.

Also shown is the cooling fluid connection point 6 of the cooling plate 51, the cooling fluid connection point consisting of a feed 61 and a return 62. The feed 61 and the return 62 are fluidically connected to the internally arranged cooling fluid channel of the cooling plate.

Furthermore, two openings 23 in the wall of the battery housing 21, in particular the bottom shell 22 of the battery housing, can be seen, through which openings the cooling fluid connection point 6, i.e., the feed 61 and the return 62 of the cooling plate 51, is led.

FIG. 1 also shows the top side 52 of the cooling plate in plan view, the top side corresponding to the side of the cooling plate 51 facing the battery module 4. This top side 52 of the cooling plate is substantially flat. This means that the side of the cooling plate facing the battery module 4 has no elevations due to the cooling fluid channel which runs inside the cooling plate 51. Conversely, the bottom side of the cooling plate 51, which is not shown in FIG. 1, is not flat, but rather has elevations that are formed by the fluid channel which runs inside the cooling plate.

FIG. 2 shows a schematic representation of a heat sink 5 according to the invention in the form of a cooling plate 51. The bottom side 53 of the cooling plate 55 from FIG. 1 is shown.

The bottom side 53 of the cooling plate has elevations which are formed by the internally arranged cooling fluid channel 54. It can also be seen that the cooling fluid channel 54, which is in the form of a cooling winding, in particular a serpentine cooling winding, has a meandering course.

Also shown is the cooling fluid connection point 6 of the cooling plate 51, said cooling fluid connection point being fluidically connected to the cooling fluid channel 54 and consisting of a feed 61 and a return 62 spatially separated from the feed, the feed 61 and the return 62 being arranged on the same side, namely one of the shorter sides 55, of the cooling plate.

The shorter side 55 and the longer side 56 of the cooling plate 51 span a plane. This plane runs substantially parallel to the top side 52 or the bottom side 53 of the cooling plate. As can be seen from FIG. 2, the cooling fluid connection point 6 of the cooling plate 51, i.e., both the feed 61 and the return 62, is arranged in this plane of the cooling plate 51.

The cooling plate 51 shown in FIG. 2 also comprises two through-openings 57 which are arranged in regions of the cooling plate 51 located next to the elevations on the bottom side 53 of the cooling plate that are caused by the cooling fluid channel 54. These through-openings 57 serve to fasten the cooling plate 51 to the battery housing 2, in particular the bottom shell 22 of the battery housing.

In each of the feed 61 and the return 62 of the heat sink, a device for reducing the pressure drop 7, namely a throttle having a calibration region, is arranged.

FIG. 3 shows a schematic representation of the detail of the cooling plate 51 marked in FIG. 2. The elevations on the bottom side 53 of the cooling plate 51, which are produced by the internally arranged cooling fluid channel 54, can again be seen.

The cooling plate 51 also comprises a collar or seam 58 which substantially completely surrounds the cooling plate 51. This collar is located in an edge region of the cooling plate 51 and is arranged on both shorter sides 55 as well as on both longer sides 56 of the cooling plate 51.

FIG. 4A shows a section through the cooling plate 51 according to FIG. 1 or 2, showing the dimensions of the cooling fluid channel 54 in detail. As can be seen, the cooling fluid channel 54 has a substantially semicircular cross section, wherein the straight side of this semicircle corresponds to the top side 52 of the cooling plate 51.

The maximum internal height of the fluid channel h is 3 mm. The maximum internal width of the fluid channel b is 19 mm. The minimum distance between two adjacent cooling loops of the cooling fluid channel d is 4 mm.

FIG. 4B shows a plan view of a detail of the bottom side 53 of the cooling plate 51 according to FIG. 1 or 2. The minimum radius of the cooling fluid channel r is 3.6 mm.

FIG. 5 shows a schematic representation of a device for reducing the pressure drop 7 according to FIG. 2 in the form of a throttle having a calibration region. The throttle 7 has an internal fluid channel and a calibration region 73 with a length I arranged between a proximal end 71 and a distal end 72 of the throttle. The length of the calibration region I is 15 mm for the throttles 7 in the feed 61 and the return 72 of FIG. 2.

FIG. 6 shows a schematic representation of a plurality of fluidically connected heat sinks 5 according to the invention in the form of cooling plates 51. Shown are five cooling plates 51 which are fluidically connected to one another and form a cooling circuit 8.

The cooling circuit 8 has a feed 81 and a return 82. The feed 81 of the cooling circuit 8 is fluidically connected to the feeds 61 of the individual cooling plates 51 in parallel via a first fluid line 83. The return 82 of the cooling circuit 8 is fluidically connected to the returns 62 of the individual cooling plates 51 in parallel via a second fluid line 83.

Contrary to the schematic representation in FIG. 6, the cooling fluid connection points 6 of the individual cooling plates 51 are arranged in the plane of the individual cooling plates 51, as shown in FIG. 2.

The individual feeds 61 and returns 62 of the respective cooling plates 51 comprise throttles 7 having calibration regions 73 of different lengths I. This reduces pressure loss.

The feed 81 and the return 82 of the cooling circuit 8 can be or are fluidically connected to a heat exchanger, which is not shown.

### List of Reference Signs

1 traction battery
2 battery housing
21 wall of the battery housing
22 half-shell of the battery housing; bottom shell of the battery housing
23 opening in the battery housing for feeding the cooling fluid connection point of the heat sink through
24 support rib
3 interior of the battery housing
4 battery module
5 heat sink
51 cooling plate
52 top side of the cooling plate; side of the cooling plate facing the battery module
53 bottom side of the cooling plate; side of the cooling plate facing away from the battery module
54 cooling fluid channel; elevations due to the internally arranged cooling fluid channel
55 shorter side of the cooling plate; width extent of the cooling plate
56 longer side of the cooling plate; length extent of the cooling plate
57 through-opening
58 collar; seam
b internal width of the fluid channel; maximum internal width of the fluid channel
d distance between two adjacent regions of the cooling plate in which a cooling fluid channel runs; distance between two cooling loops of the cooling fluid channel; minimum distance between two cooling loops of the cooling fluid channel
h internal height of the fluid channel; maximum internal height of the fluid channel
r radius of the cooling fluid channel; minimum radius of the cooling fluid channel
6 cooling fluid connection point of the heat sink
61 feed of the cooling fluid connection point of the heat sink
62 return of the cooling fluid connection point of the heat sink
7 device for reducing the pressure drop; throttle having a calibration region
71 proximal end of the device for reducing the pressure drop
72 distal end of the device for reducing the pressure drop
73 calibration region
I length of the calibration region
8 cooling circuit composed of fluidically connected heat sinks
81 feed of the cooling circuit
82 return of the cooling circuit
83 fluid line

1. A traction battery which can be temperature-controlled by means of a fluid, comprising:
a battery housing,
at least one battery module which is arranged in the interior of the battery housing and has at least one battery cell,
at least one heat sink which is arranged inside the battery housing and comprises at least one metal,
wherein the heat sink is in direct or indirect contact with the at least one battery module, wherein
the heat sink has at least one cooling fluid connection point and at least one internally arranged cooling fluid channel fluidically connected to the cooling fluid connection point.

2. The traction battery according to claim 1, wherein the heat sink is in the form of a cooling plate

3. The traction battery according to claim 1, wherein the side of the cooling plate facing the battery module is substantially flat.

4. The traction battery according to claim 1, wherein the cooling fluid channel has a meandering or serpentine course.

5. The traction battery according to claim 1, wherein the heat sink contacts the battery module indirectly via a thermal interface material arranged between the heat sink and the battery module.

6. The traction battery according to claim 1, wherein a plurality of fluidically connected cooling plates are arranged in the interior of the battery housing to generate a cooling circuit.

7. The traction battery according to claim 2, wherein the cooling fluid connection point of the cooling plate is arranged substantially in the plane of the cooling plate.

8. The traction battery according to claim 1, wherein the cooling fluid connection point has a device for reducing the pressure drop.

9. The traction battery according to claim 1, wherein the battery housing has a bottom shell, wherein the inside of the bottom shell has at least two support ribs on which the heat sink rests.

10. motor vehicle having a traction battery according to claim 1.
